(19) United States
(12) Patent Application Publication
(10) Pub. No.: US 2026/0300411 A1
(43) Pub. Date: Oct. 1, 2026

(54) A SYSTEM AND METHOD FOR EXPRESSION INGESTION AND EXPRESSION SEARCH IN MULTIPLE DOCUMENTS IN REAL-TIME

(71) Applicant: Anandji Nigam, Bangalore (IN)

(72) Inventor: Anandji Nigam, Bangalore (IN)

(21) Appl. No.: 19/480,420

(22) PCT Filed: Jun. 30, 2023
(86) PCT No.: PCT/IB2023/056838

§ 371 Date: Oct. 31, 2025

(30) Foreign Application Priority Data
May 3, 2023 (IN) 202341031594

(51) Int. Cl. G06F 16/93; G06F 16/901; G06F 16/953

(52) U.S. Cl. CPC G06F 16/93; G06F 16/9014; G06F 16/953

(57) ABSTRACT

A system 100 for expression ingestion and expression search in multiple documents in real-time is provided. The system includes an ingestion engine 108 to receive text data and assign a unique identification to the text data, a tokenization module 110 to generate a plurality of tokens for each sentence of the text data, a plurality of hashes, and match the hashes with pre-stored hashes, a datastore module 112 includes an ingestion database 114, a hash database 116, and a document database 118. The system includes a search engine 120 to receive a search query, retrieve a plurality of matched hashes, search the input expression based on a one or more predefined search rules, a rule engine 122 to perform the search for the input expression, a result generation module 124 to display the search result as one of a document number and a text content in the document.

### EARLIEST PRIORITY DATE:

This Application claims priority from a complete patent application filed in India having Patent Application No. 202341031594, filed on May 3, 2023, and titled “A SYSTEM AND METHOD FOR EXPRESSION INGESTION AND EXPRESSION SEARCH IN MULTIPLE DOCUMENTS IN REAL-TIME” and a PCT Application no. PCT/IB2023/056838 filed on Jun. 30, 2023, and titled “A SYSTEM AND METHOD FOR EXPRESSION INGESTION AND EXPRESSION SEARCH IN MULTIPLE DOCUMENTS IN REAL-TIME”

### FIELD OF INVENTION

Embodiments of a present disclosure relate to digital services and more particularly to a system and a method for expression ingestion and expression search in multiple documents in real-time.

### BACKGROUND

In this digital era, information is required at the fingertips. A user can easily obtain required information through digital devices, just by entering a few keywords in a search engine. The search engine is an application that helps users to find the information they are looking for, by using keywords or phrases. Typically, the search engine can return results quickly, even with millions of websites online, by scanning the internet continuously and indexing every page that is retrieved.

Although, various search engines are available, finding a given text expression in multiple text documents in real-time is a problem. The currently existing search engines do not take the text input in the order it is entered and therefore are not flexible and less accurate. In the existing search engines, the order information of the word in a text is lost and hence sometimes it may lead to lesser accurate search results. Also, the existing search engines are not suitable for multiple text documents, for instance, blogs, stories, and paragraphs.

There is a need for a system for finding a given text expression in multiple text documents in real-time. Also, there is a need for a system that has devised a way to ingest the input text in such a way that the ordering of words in the sentences is retained. Further, there is a need for a system that may provide speedy ingestion of the text in the search engine. Furthermore, there is a need for the system that allows search for ordered words in real time.

Hence, there is a need for a system for expression ingestion and expression search which addresses the aforementioned issues.

### BRIEF DESCRIPTION

In accordance with one embodiment of the disclosure, a system for expression ingestion and expression search in multiple documents in real-time is provided. The system includes a processing subsystem, hosted on a server, and configured to execute on a network to control bidirectional communications among a plurality of modules. The plurality of modules includes an ingestion engine, a tokenization module, a datastore module, a search engine, a rule engine, and a result generation module. The ingestion engine is operatively coupled to a data store database wherein the ingestion engine is configured to receive a plurality of text data. Each of the plurality of text data comprises multiple sentences with a sequence of multiple words pertaining to an order of information. The ingestion engine is also configured to assign a unique identification to each of the plurality of the text data. The tokenization module is operatively coupled to the ingestion engine wherein the tokenization module is configured to generate a plurality of tokens for each sentence in each of the plurality of text data wherein the plurality of tokens is obtained by splitting each sentence into a plurality of sub-sentences. Each sub-sentence comprises an incremental number of words pertaining to the sequence and splits each sentence into a plurality of sub-sentences based on an incremental start index corresponding to each of the plurality of sub-sentences. The splitting of the sentence ensures that an order of information of the text data is preserved. The tokenization module is also configured to generate a plurality of hashes wherein each of the plurality of hashes comprises a hash, a sub-sentence length, a start index, and a unique number. Further, the tokenization module is configured to map the plurality of hashes corresponding to each of the plurality of tokens. Furthermore, the tokenization module generates a plurality of hashes and matches the plurality of hashes with pre-stored hashes, wherein the plurality of hashes is used to map a text data of arbitrary size value to fixed-size value. Further, the tokenization module is configured to split a search query into sub-sentences with corresponding hashes wherein the search query is split into a plurality of sub-sentences wherein each sub-sentence comprises an incremental number of words pertaining to the sequence and splitting each sentence into a plurality of sub-sentences based on an incremental start index corresponding to each of the plurality of sub-sentences. The datastore module is operatively connected with the ingestion engine. The datastore module includes an ingestion database is operatively coupled to the ingestion engine and search engine. The ingestion database is configured to store the plurality of text data with the corresponding unique identification. The ingestion database is a dynamic database. The datastore module also includes a search database is operatively coupled to the search engine. The search database is configured to store a plurality of search data and modified text data, modified by the user.

Each text data of the plurality of text data is assigned with a document identification. The search engine is operatively connected with the ingestion engine and the datastore module. The search module is configured to receive a search query from a user to find an input expression from the plurality of text data. Further, the search module is configured to search the hashes in the hash database and match the hashes. Furthermore, the search module is configured to retrieve a plurality of matched hashes in response to the searched hash, wherein the matched hashes indicate one or more corresponding unique identifications pertaining to the plurality of text data. Furthermore, the search module is configured to search the input expression based on a one or more predefined search rules and map the input expression to the plurality of hashes while maintaining the sequence. The rule engine is operatively coupled to the search engine. The rule engine is configured to perform the search for the input expression based on the one or more pre-defined search rules. The result generation module is operatively connected with the search engine and the rule engine. The result generation module displays the search result as at least one of the document number and the text content in document.

In accordance with another embodiment, a method for operating a system for expression ingestion and expression search in multiple documents in real-time is provided. The method includes receiving, by an ingestion engine of a processing sub-system, a plurality of text data wherein each of the plurality of text data comprises multiple sentences with a sequence of multiple words pertaining to an order of information. The method also includes assigning, by the ingestion engine of the processing sub-system, a unique identification to each of the plurality of the text data. Further, the method includes generating, by a tokenization module of the processing sub-system, a plurality of tokens for each sentence in each of the plurality of text data. The plurality of tokens is obtained by splitting each sentence into a plurality of sub-sentences wherein each sub-sentence comprises an incremental number of words pertaining to the sequence and incremental number of words with a start index of each sub sentence and creating subsentences ensuring that the order information is preserved. Furthermore, the method includes generating, by the tokenization module of the processing sub-system, a plurality of hashes wherein each of the plurality of hashes comprises a hash, a token count, a start index and a unique identification. Furthermore, the method includes mapping, by the tokenization module of the processing sub-system, the plurality of hashes corresponding to each of the plurality of tokens. Furthermore, the method includes generating, by the tokenization module of the processing sub-system, a plurality of hashes and matching the plurality of hashes with pre-stored hashes the plurality of hashes is used to map a text data of arbitrary size value to fixed-size value. Furthermore, the method includes storing, by an ingestion database of a datastore module, the plurality of text data with the corresponding unique identification, wherein the ingestion database is a dynamic database. Furthermore, the method includes storing, by a hash database of the datastore module of the processing sub-system, the generated plurality of tokens and the plurality of hashes. Furthermore, the method includes storing, by a document database of the datastore module of the processing subsystem, the plurality of text data, wherein a document identification number is assigned to each text data of the plurality of text data. Furthermore, the method includes receiving, by a search engine of the processing sub-system, a search query from a user to find an input expression from the plurality of text data. Furthermore, the method includes splitting, by the tokenization module of the processing sub-system, the search query into sub-sentences with corresponding hashes. Furthermore, the method includes searching, by the search engine of the processing sub-system, the hashes in the hash database and matching the hashes. Furthermore, the method includes retrieving, by the search engine of the processing subsystem, a plurality of matched hashes in response to the searched hash, wherein the matched hashes indicate one or more corresponding unique identifications pertaining to the plurality of text data. Furthermore, the method includes searching, by the search engine of the processing subsystem, the input expression based on a one or more predefined search rules and maps. The input expression to the plurality of hashes while maintaining the sequence. Furthermore, the method includes performing, by a rule engine of the processing subsystem, the search for the input expression based on the one or more pre-defined search rules. Furthermore, the method includes displaying, by a result generation module, of the processing subsystem, the search result as at least one of the document number and the text content in document.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a system for expression ingestion and expression search in accordance with an embodiment of the present disclosure;

FIG. 2 is a block diagram representing an exemplary embodiment of an ingestion engine of FIG. 1. In accordance with an embodiment of the present disclosure;

FIG. 3 is a block diagram representing an exemplary embodiment of a search engine of FIG. 1 in accordance with an embodiment of the present disclosure;

FIG. 4 is a block diagram representing a data flow in the system for expression ingestion and expression search of FIG. 1 in accordance with an embodiment of the present disclosure;

FIG. 5 is a block diagram representing an exemplary embodiment of a datastore module of FIG. 1 in accordance with an embodiment of the present disclosure;

FIG. 6 is a block diagram of a computer or a server for the system for expression ingestion and expression search in accordance with an embodiment of the present disclosure;

FIG. 7 (a) is a flow chart representing steps involved in a method for operating the system for expression ingestion and expression search in accordance with an embodiment of the present disclosure; and

FIG. 7 (b) illustrates continued steps of the method of FIG. 7(a) in accordance with an embodiment of the present disclosure.

Further, those skilled in the art will appreciate that elements in the figures are illustrated for simplicity and may not have necessarily been drawn to scale. Furthermore, in terms of the construction of the system, one or more components of the system may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises” a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for expression ingestion and expression search in multiple documents in real-time is provided. The system includes a processing subsystem, hosted on a server, and configured to execute on a network to control bidirectional communications among a plurality of modules. The plurality of modules includes an ingestion engine, operatively connected to a third-party database. The ingestion engine is configured to receive a plurality of text data. Each of the plurality of text data includes multiple sentences with a sequence of multiple words pertaining to an order of information. The ingestion engine is also configured to assign a unique identification to each of the plurality of the text data. A tokenization module is operatively coupled to the ingestion engine. The tokenization module is configured to generate a plurality of tokens for each sentence in each of the plurality of text data. The plurality of tokens is obtained by splitting each sentence into a plurality of sub-sentences. Each sub-sentence is derived in two ways, an incremental number of words pertaining to the sequence and incremental number of words with a start index of each sub-sentence. The splitting of the sentence ensures that an order of information of the text data is preserved. The tokenization module is also configured to generate a plurality of hashes. Each of the plurality of hashes includes a hash, a sub-sentence length count, a start index, and a unique identification. Further, the tokenization module is configured to map the plurality of hashes corresponding to each of the plurality of tokens. Furthermore, the tokenization module generates a plurality of hashes and matches the plurality of hashes with pre-stored hashes, wherein the plurality of hashes is used to map a text data of arbitrary size value to fixed-size value. The datastore module is operatively connected with the ingestion engine. The datastore module includes an ingestion database is operatively coupled to the ingestion engine. The ingestion database is configured to store the plurality of text data with the corresponding unique identification. The ingestion database is a dynamic database. The search database is operatively coupled to the search engine. The search database is configured to store a plurality of search data and modified text data, modified by the user. Each text data of the plurality of text data is assigned with a document identification. The search engine is operatively connected with the ingestion engine and the datastore module. The search module is configured to receive a search query from a user to find an input expression from the plurality of text data. The search module is also configured to split the search query into sub-sentences with corresponding hashes. Further, the search module is configured to search the hashes in the hash database and match the hashes. Furthermore, the search module is configured to retrieve a plurality of matched hashes in response to the searched hash. The matched hashes indicate one or more corresponding unique identifications pertaining to the plurality of text data. Furthermore, the search engine is configured to search the input expression based on a one or more predefined search rules and map the input expression to the plurality of hashes while maintaining the sequence. The rule engine is operatively coupled to the search engine. The rule engine is configured to perform the search for the input expression based on the one or more pre-defined search rules. The result generation module is operatively connected with the search engine and the rule engine. The result generation module displays the search result as the document number and the text content in document.

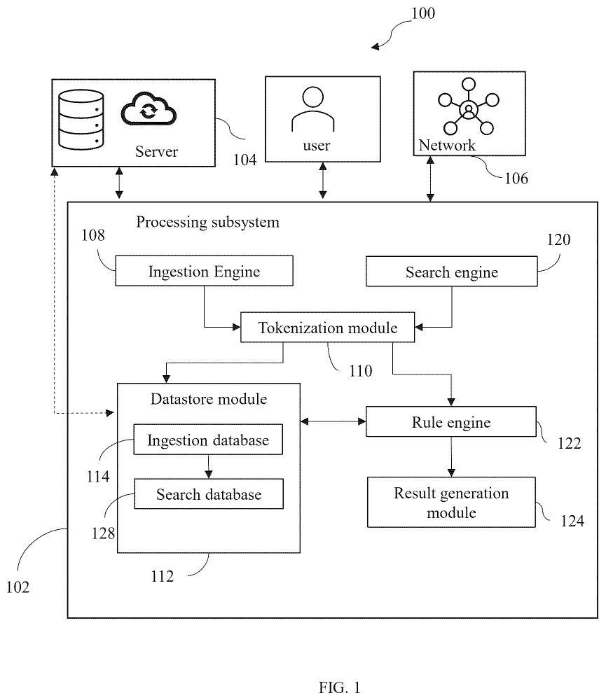

Further, the system described hereafter in FIG. 1 is the system for expression ingestion and expression search in multiple documents in real-time.

FIG. 1 is a block diagram representing a system 100 for expression ingestion and expression search in multiple documents in real-time in accordance with an embodiment of the present disclosure. The system 100 includes a processing subsystem 102. The processing subsystem 102 is hosted on a server 104 and configured to execute on a network 106 to enable communications among a plurality of modules. In one embodiment, the server 104 may include a cloud server. In another embodiment, the server 104 may include a local server. The processing subsystem 102 is configured to execute on the network 106 to control bidirectional communications among a plurality of modules. In one embodiment, the network 106 is a connection between a user and the server where the system 100 is hosted. In one embodiment, the network 106 may include a wired network such as a local area network (LAN). In another embodiment, the network technologies may include a wireless network such as Wi-Fi, Bluetooth, Zigbee, near field communication (NFC), infra-red communication (RFID), and the like. The plurality of modules includes an ingestion engine 108, a tokenization module 110, a datastore module 112, a search engine 120, a rule engine 122, and a result generation module 124. In one embodiment, the system 100 includes a plug-in at a user side configured for communication between the processing subsystem 102 and a user.

The ingestion engine 108 is operatively coupled to a third-party database (not shown in FIG. 1). Typically, the third-party database is a client database. The ingestion engine 108 is configured to receive a plurality of text data from the third-party database wherein the plurality of text data comprises multiple sentences with a sequence of multiple words pertaining to an order of information. The ingestion module 108 is also configured to assign a unique identification to each of the plurality of the text data. In one embodiment, the text data of the plurality of text data includes a document information, wherein the document information comprises a sub-sentence length, a starting point of the subsentence in the sentence, a sentence number in the document, a global index assigned to each sentence, and a document identification number to identify the text data.

In one embodiment, the ingestion of the plurality of text data occurs in real time.

The tokenization module 110 is operatively coupled to the ingestion engine 108. The tokenization module 110 is configured to generate a plurality of tokens for each sentence in each of the plurality of text data. The plurality of tokens is obtained by splitting each sentence into a plurality of sub-sentences. Each sub-sentence is derived in two ways, an incremental number of words pertaining to the sequence and incremental number of words with a start index of each sub-sentence. The tokenization module 110 is also configured to generate a plurality of hashes wherein each of the plurality of hashes includes a hash, a sub-sentence length, a start index, and a unique identification. Further, the tokenization module 110 is configured to map the plurality of hashes corresponding to each of the plurality of tokens. Furthermore, the tokenization module 110 is configured to generate a plurality of sub-sentences and its respective a plurality of hashes. The plurality of hashes is used to map text data of an arbitrary size value to a fixed-size value.

It must be noted that the text data received by the ingestion engine 108 confines to a particular word order (also referred to as order of information herein). This word order of the text data is preserved during the splitting of sentences and acts as an essential feature of the present disclosure.

In one embodiment, noise from the text data may be removed to enable accurate results. The noise refers to common words (such as, ‘is’, ‘it’, ‘she’, ‘can’ and the like) and special characters (such as ‘&’, ‘?’, ‘@’ and the like).

The datastore module 112 operatively connected with the ingestion engine 108. The datastore module 112 includes an ingestion database 114. The ingestion database 114 is operatively coupled to the ingestion engine 108. The ingestion database 114 is configured to store the plurality of text data with the corresponding unique identification. In one embodiment, the ingestion database 114 is stored in the form of tables and functions as a relational database management system (RDBMS). The search database 128 operatively coupled to the search engine 120. The search database 128 is configured to store a plurality of search data and modified text data, modified by the user.

The search engine 120 is operatively connected with the tokenization module 110 and the datastore module 112. The search engine 120 is configured to receive a search query from a user to find an input expression from the plurality of text data. Upon receiving the search query in the form of an expression, the said expression is forwarded to the tokenization module 110 where splitting of the search query takes place. It must be noted that the splitting of the search query is performed as described aforementioned in paragraph 0027. Further, the search engine 120 is configured to search the hashes in the hash database and match the hashes. Furthermore, the search engine 120 is configured to retrieve a plurality of matched hashes in response to the searched hash. The matched hashes indicate one or more corresponding unique identifications pertaining to the plurality of text data. Furthermore, the search engine 120 is configured to search the input expression based on a one or more predefined search rules and map the input expression to the plurality of hashes while maintaining the sequence. In one embodiment, the search engine 120 is configured to search the text in the third-party application hosted on the server 104. In one embodiment, the search engine 120 is configured to remove noise from the text data that are input for search engine 120.

It must be noted that the word order (described in paragraph 0028) is also preserved during the search process.

The rule engine 122 is operatively coupled to the search engine 120 wherein the rule engine 122 is configured to perform the search for the input expression based on the one or more pre-defined search rules. In one embodiment, the rule engine 122 is customizable by the user.

The result generation module 124 operatively connected with the search engine 120 and the rule engine 122. The result generation module 124 displays the search result as at least one of a document number and a text content in document. In one embodiment, the result generation module 124 is configured to receive the plurality of pre-defined rules from the rule engine 122. In one embodiment, the pre-defined rules are flexible and accurate to generate a personalized result for multiple requirements. In another embodiment, the pre-defined rules include returning the full-text matches or partial text matches, ordered or unordered matches, and accurate text matches. In another embodiment, the rule engine 122 may be customizable by the user based on the requirement of the search.

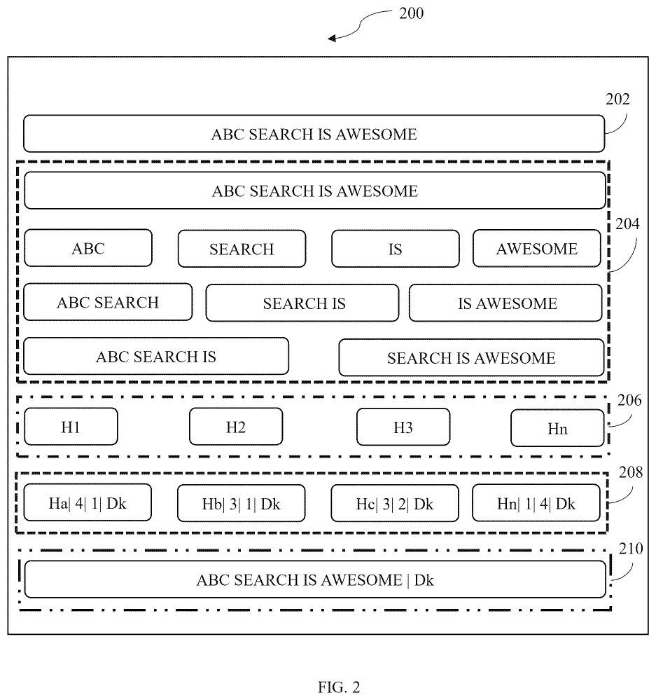

FIG. 2 is a block diagram representing an exemplary embodiment of an ingestion engine 108 of FIG. 1 in accordance with an embodiment of the present disclosure. Considering a non-limiting example of the ingestion engine 108, a sentence ‘ABC SEARCH IS AWESOME’ 200 is ingested as an input text with length of the input text equal to ‘four’. The input text is first saved in a database with a corresponding unique identification/document identity, for instance ‘Dk’ 210. Further, it must be noted that each word in the input text is assigned an index value. For instance, the index of ‘ABC’ is 1, the index of ‘SEARCH’ is 2, the index of ‘IS’is 3 and the index of ‘AWESOME’is 4.

The ingestion engine 108 splits the sentence into individual words and a group of words while maintaining the order of the ingested sentence 204. In other words, the splitting is done by breaking of the sentence into multiple sub-sentences with an incremental number of words until the length (four) of the input text has reached. Each sub-sentence is called as a ‘token’. For instance, the splitting of the sentence ‘ABC SEARCH IS AWESOME’ is as follows:
a. A (length=1)—‘ABC’ ‘SEARCH’ ‘IS’ ‘AWESOME’,
b. B (length=2)—‘ABC SEARCH’ ‘SEARCH IS’ ‘IS AWESOME’,
c. C (length=3)—‘ABC SEARCH IS’ ‘SEARCH IS AWESOME’
d. D (length=4)—‘ABC SEARCH IS AWESOME’

It must be observed that each word in the input text forms a sub-sentence, for instance, ‘ABC’, ‘SEARCH’, ‘IS’ and ‘AWESOME’. Here, each sub-sentence includes only one word. Let's consider these words as ‘A’ type.

Next, another set of sub-sentences are formed by increasing the number of words to two, for instance, ‘ABC SEARCH’, ‘SEARCH IS’ and ‘IS AWESOME’. Here, it can be observed that each sub-sentence includes two words. Let's consider these words as ‘B’type.

Similarly, the next set of sub-sentences are formed with three words in each sub-sentence, for instance, ‘ABC SEARCH IS’ and ‘SEARCH IS AWESOME’. Let's consider these words as ‘C’ type.

Finally, the next sub-sentence is formed with four words thereby reaching the length of the input text, for instance, ‘ABC SEARCH IS AWESOME’.

Once the splitting of the input text into sub-sentences is completed, hashes are generated and assigned to each subsentence/token 208. Subsequently, each token and its corresponding hash is stored in the hash database. For instance, the stored hash for ‘ABC SEARCH IS AWESOME’ is ‘Ha|4 1|Dk’. This indicates that hash ‘Ha’ of sub-sentence length is 4 and is starting at index 1 in the input text named as ‘Dx’.

Another way of splitting the sentence is by incrementing the number of words at the start of each sub-sentence. Considering the example in paragraph.

The sentence ‘ABC SEARCH IS AWESOME’ 200 is ingested and the index assigned to the ‘ABC’ is 1, the index of ‘SEARCH’ is 2, the index of ‘IS’ is 3 and the index of ‘AWESOME’ is 4. The splitting of the sentence begins with index value 1 and is iterated for subsequent index values of 2, 3 and 4 respectively.

Consider index value 1, the sentence is split into the following sub-sentences: ‘ABC’, ‘ABC SEARCH’, ‘ABC SEARCH IS’ AND ‘ABC SEARCH IS AWESOME’.

Consider index value 2, the sentence is split into the following sub-sentences: ‘SEARCH’, ‘SEARCH IS’ and ‘SEARCH IS AWESOME’.

Consider index value 3, the sentence is split into the following sub-sentences: ‘IS’ and ‘IS AWESOME’

Consider index value 4, the sentence is split into sub-sentence ‘AWESOME’.

Therefore, it can be seen that the splitting process is incremental in nature.

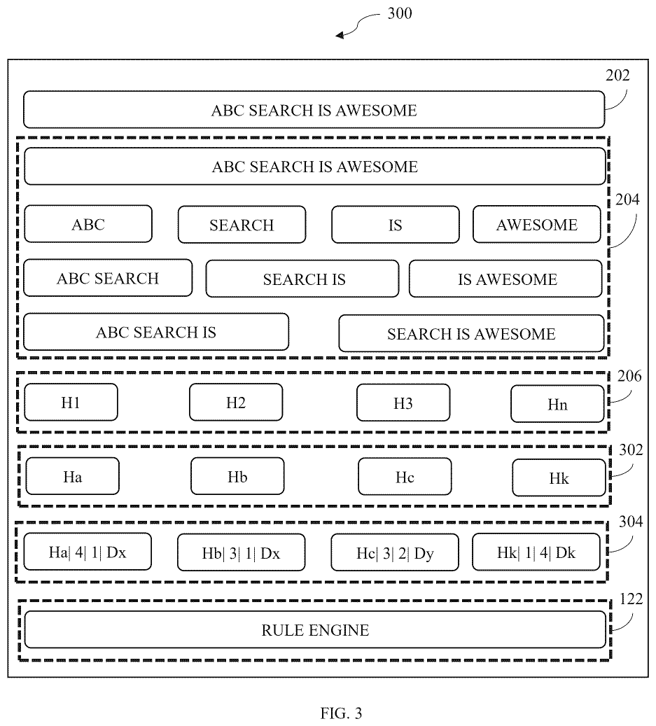

FIG. 3 is a block diagram representing an exemplary embodiment of a search engine 120 of FIG. 1. in accordance with an embodiment of the present disclosure. In one embodiment, the search engine 108 receives a search query from a user ‘ABC SEARCH IS AWESOME’ 302. The search query is then split into sub-sentences/tokens along with maintaining the sequence/order of words 304. The tokens are ‘ABC SEARCH IS AWESOME’, ‘ABC’, ‘SEARCH’, ‘IS’, AWESOME’, ‘ABC SEARCH’, ‘SEARCH IS’, ‘IS AWESOME’, ‘ABC SEARCH IS’ and ‘SEARCH IS AWESOME’. For each token, a hash is generated and assigned 306. The generated hashes are matched with the stored hashes to provide accurate results.

At this point, the search based on the search query is performed in the hash database to find matching hashes 308. The results based on the matched hashes are displayed to the user 310. For instance, ‘Ha|4 1|Dx’ indicates that the search query ‘ABC SEARCH IS AWESOME’ was found with a matched hash ‘Ha’ in document Dx. The sub-sentence length is 4 and starts at index 1. Likewise, consider the result ‘Hc|3|2|Dy’. This indicates that the search query ‘ABC SEARCH IS AWESOME’ was found with hash ‘Hc’ in document ‘Dy’. The matched length is 3 and starts at index 2. This means that ‘SEARCH IS AWESOME’ was found in document ‘Dy’.

The corresponding hashes are searched in the hash database 116 and the hashes in the hashes database are then mapped with the corresponding hashes. The matched hashes are then retrieved in response to the searched hash. The matched hashes are then assigned with the corresponding unique identifications pertaining to text. The ‘ABC SEARCH IS AWESOME’ is then searched based on the predefined search rules. The mapping is done while maintaining the sequence of the sentence.

The rule engine 122 is flexible and includes search rules that may search the full or partial text of any length searches, ordered and unordered text searches, and a combination of these two. In an exemplary embodiment, the rule engine 122 includes rules for:
Return All Full-text Matches
   Return words in ordered sequence within a document.
   Return in any sequence within a document.
Return All Largest text matches with greater than X % match.
   Return words in ordered sequence within a document.
   Return in any sequence within a document.
Return All Largest text matches with X % matched.
   Return words in ordered sequence within a document.
   Return in any sequence within a document.
Return all matches bigger than X size.
   Return words in ordered sequence within a document.
   Return in any sequence within a document.
Return All Matches of X Size
   Return words in ordered sequence within a document.
   Return in any sequence within a document.
   Return if greater than or equal to Y matches

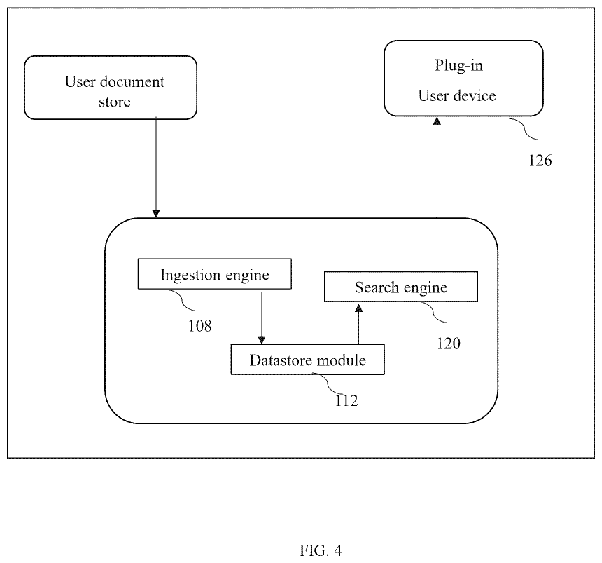

FIG. 4 is a block diagram representing a data flow in the system expression ingestion and expression search in multiple documents in real-time of FIG. 1 in accordance with an embodiment of the present disclosure. In one embodiment, a text document in any data format is ingested to the ingestion engine 108 from a user document database. The ingested document is then sent to the datastore module 112. The search engine 120 fetches the documents, hashes, and tokens from the datastore module 112 and operate on the respective data to find search result. In one embodiment, the system 100 includes a plug-in 126 at a user side for communicating between the processing subsystem 102 and the user. The search engine 120 sends the search result to the user side plug-in 126 device. The result generation module 124 displays result of the search engine 120 on the user side device.

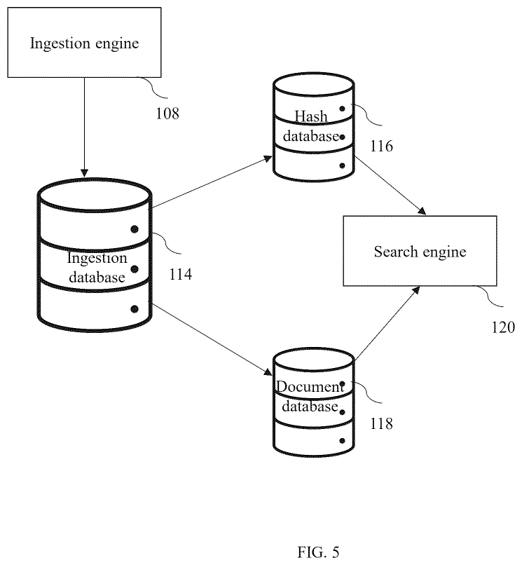

FIG. 5 is a block diagram representing an exemplary embodiment of the datastore module 112 of FIG. 1 in accordance with an embodiment of the present system. In one embodiment, the ingestion database 114 is a dynamic database. In one embodiment, the ingestion data base functions as relational database management system (RDBMS). The RDBMS is a system used to store, manage, query, and retrieve data stored in a relational database. In one embodiment, the datastore module 112 includes a hash database 116 to store the plurality of generated hashes. The hash database 116 is configured to store the generated plurality of tokens and the plurality of hashes. The document database 118 is operatively connected with the ingestion database 114 and configured to store the plurality of text data. A document identification number is assigned to each text data of the plurality of text data. In one embodiment, the document identification number is generated when the document is ingested in the ingestion engine 108.

In one embodiment, the hash database 116 stores hashes in-Memory along with a key value. The key is the token Hash, and the value is the word count, start index, document Id, and the like stored in the hash database 116. In one embodiment, the document database 118 stores the document id and document text in the form of key and value, that is the document id as a key and the document text as a value In one embodiment, when the user inputs a search query, the hash database 116 is configured to enable the search, and the document database 118 is configured to provide the result for the requested search.

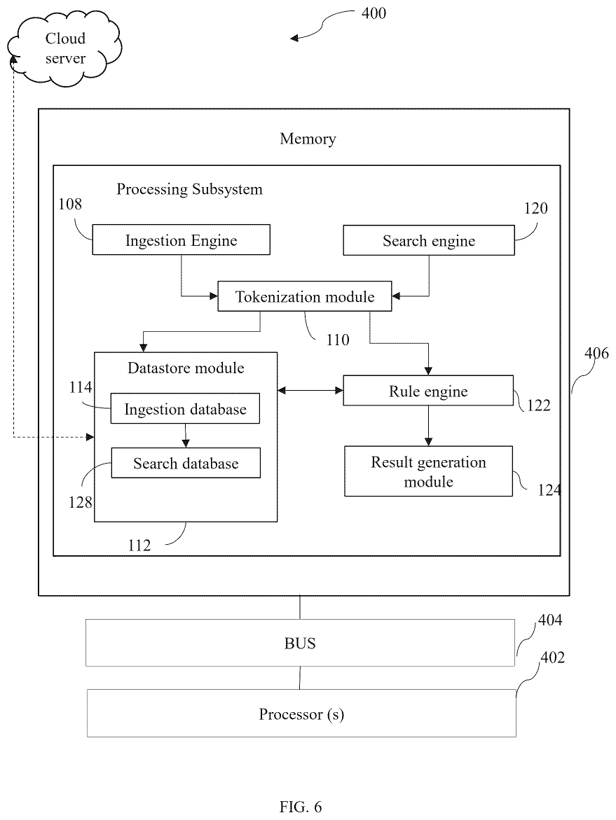

FIG. 6 is a block diagram of a computer or a server 104 for the system for expression ingestion and expression search in multiple documents in real-time in accordance with an embodiment of the present disclosure. The server 104 includes processor(s) 402, and memory 406 operatively coupled to the bus 404.

The processor(s) 402, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The bus 404 as used herein refers to internal memory channels or computer network that is used to connect computer components and transfer data between them. The bus 404 includes a serial bus or a parallel bus, wherein the serial bus transmits data in a bit-serial format and the parallel bus transmits data across multiple wires. The bus 404 as used herein, may include but not limited to, a system bus, an internal bus, an external bus, an expansion bus, a frontside bus, a backside bus, and the like.

The memory 406 includes a plurality of subsystems and a plurality of modules stored in the form of an executable program which instructs the processor 402 to perform the method steps illustrated in FIG. 1. The memory 406 is substantially similar to the system 100 of FIG. 1. The memory 406 has following submodules: The plurality of modules includes an ingestion engine 108, a tokenization module 110, a datastore module 112, a search engine 120, a rule engine 122, and a result generation module 124.

The ingestion engine 108 is operatively coupled to a third-party database. The ingestion engine 108 is configured to receive a plurality of text data wherein each of the plurality of text data comprises multiple sentences with a sequence of multiple words pertaining to an order of information. The ingestion module 108 is also configured to assign a unique identification to each of the plurality of the text data. In one embodiment, the ingestion engine 108 creates an inverted index after the tokens are generated, wherein the inverted index is used to map each word into the received text data of the plurality of text data.

The tokenization module 110 is operatively coupled to the ingestion engine 108. In one embodiment, the tokenization module is operatively coupled with the search engine 120 and ingestion engine 108. The tokenization module creates subsentences ensuring that the order information is preserved. In one embodiment, the ordering information is captured during both-ingestion and search. During the ingestion, the ordering information is stored in the ingestion database 114 and the search engine 120 may operate on ordered or unordered data or both. The tokenization module 110 is configured to generate a plurality of tokens for each sentence in each of the plurality of text data. The plurality of tokens is obtained by splitting each sentence into a plurality of sub-sentences wherein each sub-sentence comprises an incremental number of words pertaining to the sequence. The tokenization module 110 is also configured to generate a plurality of hashes wherein each of the plurality of hashes comprises a hash, a sub-sentence length, a start index, and a unique identification. Further, the tokenization module 110 is configured to map the plurality of hashes corresponding to each of the plurality of tokens. Furthermore, the tokenization module 110 is configured to generate a plurality of hashes and match the plurality of hashes with pre-stored hashes. The plurality of hashes is used to map text data of arbitrary size value to fixed-size value.

The datastore module 112 is operatively connected with the ingestion engine 108. The datastore module 112 includes an ingestion database 114, and a search, database 128. The ingestion database 114 is operatively coupled to the ingestion engine 108. The ingestion database 114 is configured to store the plurality of text data with the corresponding unique identification. In one embodiment, the text data is received from the source and stored into the ingestion database 114 In one embodiment, the ingestion database 114 is configured to store a plurality of documents and generated hashes.

The search database 128 operatively coupled to the search engine 120. The search database 128 is configured to store a plurality of search data and modified text data, modified by the user.

The search engine 120 is operatively connected with the ingestion engine 114 and the datastore module 112. The search engine 120 is configured to receive a search query from a user to find an input expression from the plurality of text data. Further, the search engine 120 is configured to search the hashes in the hash database and match the hashes. Furthermore, the search engine 120 is configured to retrieve a plurality of matched hashes in response to the searched hash. The matched hashes indicate one or more corresponding unique identifications pertaining to the plurality of text data. Furthermore, the search engine 120 is configured to search the input expression based on a one or more predefined search rules and map the input expression to the plurality of hashes while maintaining the sequence.

The rule engine 122 is operatively coupled to the search engine 120 wherein the rule engine 122 is configured to perform the search for the input expression based on the one or more pre-defined search rules.

The result generation module 124 operatively connected with the search engine 120 and the rule engine 122. The result generation module 124 displays the search result as at least one of the document numbers and the text content in the document. Computer memory elements may include any suitable memory device(s) for storing data and executable programs, such as read only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 302.

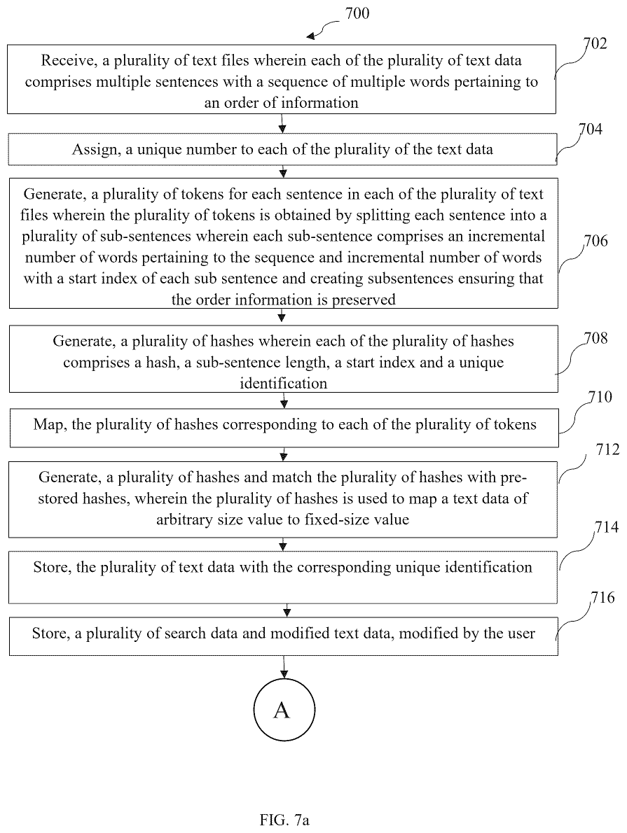

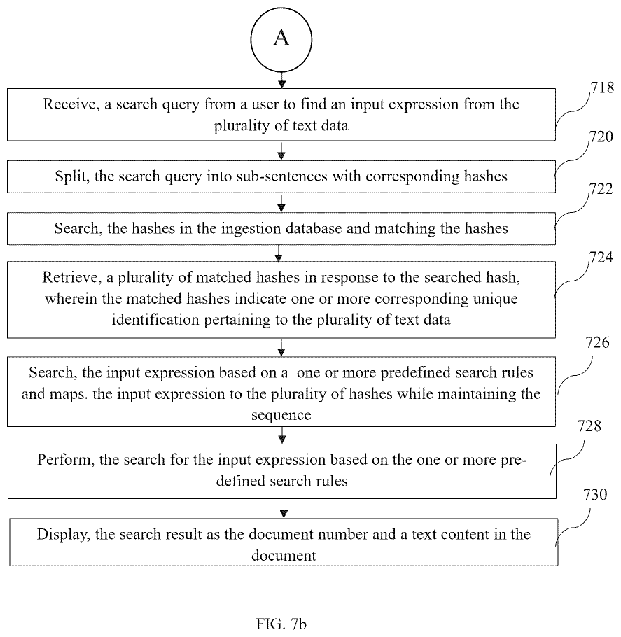

FIG. 7 (a) is a flow chart representing steps involved in a method for operating the system 100 for expression ingestion and expression search in multiple documents in real-time in accordance with an embodiment of the present disclosure and FIG. 7 (b) illustrates continued steps of the method of FIG. 7(a) in accordance with an embodiment of the present disclosure. The method 700 includes receiving, by an ingestion engine of a processing sub-system, a plurality of text data wherein each of the plurality of text data comprises multiple sentences with a sequence of multiple words in step 702.

The method 700 also includes assigning, by the ingestion engine of the processing sub-system, a unique identification to each of the plurality of the text data in step 704.

Further, the method 700 includes generating, by a tokenization module of the processing sub-system, a plurality of tokens for each sentence in each of the plurality of text data. The plurality of tokens is obtained by splitting each sentence into a plurality of sub-sentences. Each sub-sentence is derived as an incremental number of words pertaining to the sequence in step 706. The method also includes deriving, each sub-sentence as an incremental number of words with a start index of each sub-sentence. The method also includes creating subsentences ensuring that the order information is preserved. The method also includes capturing, an ordering information is captured during both-ingestion and search. During the ingestion, the ordering information is stored in the ingestion database and the search engine may operate on ordered or unordered data or both.

Furthermore, the method 700 includes generating, by the tokenization module of the processing sub-system, a plurality of hashes wherein each of the plurality of hashes comprises a hash, a sub-sentence length, a start index and a unique identification in step 708.

Furthermore, the method 700 includes mapping, by the tokenization module of the processing sub-system, the plurality of hashes corresponding to each of the plurality of tokens in step 710.

Furthermore, the method 700 includes generating, by the tokenization module of the processing sub-system, a plurality of hashes and matching the plurality of hashes with pre-stored hashes, wherein the plurality of hashes is used to map a text data of arbitrary size value to fixed-size value in step 712.

Furthermore, the method 700 includes storing, by an ingestion database of a datastore module, the plurality of text data with the corresponding unique identification and the generated hashes. 714.

Furthermore, the method 700 includes storing, by a hash database of the datastore module of the processing sub-system, the generated plurality of tokens and the plurality of hashes in step 716.

Furthermore, the method 700 includes storing, by a document database of the datastore module of the processing subsystem, the plurality of text data, wherein a document identification number is assigned to each text data of the plurality of text data in step 718. The method also includes providing, the text data of the plurality of text data including a document information. The document information includes a sub-sentence length, a starting point of the subsentence in the sentence, a, a global index assigned to each sentence, and a document identification number to identify the input document. The method also includes generating a document identification number when the document is ingested in the ingestion engine.

Furthermore, the method 700 includes receiving, by a search engine of the processing sub-system, a search query from a user to find an input expression from the plurality of text data in step 720.

Furthermore, the method 700 includes splitting, by the tokenization module of the processing sub-system, the search query into sub-sentences with corresponding hashes in step 722.

Furthermore, the method 700 includes searching, by the search engine of the processing sub-system, the hashes in the hash database and matching the hashes in step 724.

Furthermore, the method 700 includes retrieving, by the search engine of the processing subsystem, a plurality of matched hashes in response to the searched hash, wherein the matched hashes indicate one or more corresponding unique identifications pertaining to the plurality of text data in step 726.

Furthermore, the method 700 includes searching, by the search engine of the processing subsystem, the input expression based on one or more predefined search rules and maps. the input expression to the plurality of hashes while maintaining the sequence in step 728. The method includes ssearching, the text in the third-party application hosted on the server.

Furthermore, the method 700 includes performing, by a rule engine of the processing subsystem, the search for the input expression based on the one or more pre-defined search rules in step 730. The method also includes customizing, the rules by the user.

Furthermore, the method 700 includes displaying, by a result generation module, of the processing subsystem, the search result as at least one of the document numbers and the text content in document in step 732. The method also includes receiving the plurality of pre-defined rules returning, at ease one of the full-text matches or partial text matches, ordered or unordered matches, and accurate text matches. In another embodiment, the rule engine 122 may be customizable by the user based on the requirement of the search. Furthermore, the method 700 includes comprises a plug-in at a user side configured for communication between the processing subsystem and the user.

Various embodiments of the present disclosure provides expression ingestion and expression search in multiple documents in real-time by dividing a sentence into sub-sentences. The present system provides higher accuracy of search results. Also, the system in the present disclosure provides faster ingestion. Further, the present system facilitates faster search which is also suitable for real-time search. The system in the present disclosure facilitates searching of a sentence, as the system provides search result without changing the order of the ingested sentence therefore making the search process flexible and more accurate. The system facilitates text search in various platforms such as a third-party web platform.

Further, the system disclosed in the present disclosure provides multiple document searching at the same time. The system in the present disclosure is cost effective. The system facilitates generating insight into any domain. The system in the present disclosure, provides a flexible and more accurate search engine.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim

1. A system for expression ingestion and expression search in multiple documents in real time comprises:
a processing subsystem, hosted on a server and configured to execute on a network to control bidirectional communications among a plurality of modules comprising:
an ingestion engine operatively coupled to a datastore module wherein the ingestion engine is configured to:
receive a plurality of text data wherein each of the plurality of text data comprises multiple sentences with a sequence of multiple words pertaining to an order of information; and
assign a unique identification to each of the plurality of the text data;
a tokenization module operatively coupled to the ingestion engine wherein the tokenization module is configured to:
generate a plurality of tokens for each sentence in each of the plurality of text data wherein the plurality of tokens is obtained by splitting each sentence into a plurality of sub-sentences wherein each sub-sentence comprises an incremental number of words pertaining to the sequence and the splitting of each sentence into a plurality of sub-sentences is based on an incremental start index corresponding to each of the plurality of sub-sentences and wherein the splitting of each sentence ensures that the order of information is preserved;
generate a plurality of hashes wherein each of the plurality of hashes comprises a hash, a sub-sentence length, a start index, and a unique identification;
map the plurality of hashes corresponding to each of the plurality of tokens;
generate a plurality of hashes and match the plurality of hashes with pre-stored hashes, wherein the plurality of hashes is used to map text data of arbitrary size value to fixed-size value;
split a search query into sub-sentences with corresponding hashes wherein the search query is split into a plurality of sub-sentences wherein each sub-sentence comprises an incremental number of words pertaining to the sequence and splitting each sentence into a plurality of sub-sentences based on an incremental start index corresponding to each of the plurality of sub-sentences;
a search engine operatively connected with the tokenization module and the datastore module, wherein the search module is configured to:
receive the search query from a user to find an input expression from the plurality of text data;
search the hashes corresponding to the search query in the hash database thereby matching the hashes of the search query to the hashes of the plurality of text data;
retrieve a plurality of matched hashes in response to the searched hash, wherein the matched hashes indicate one or more corresponding unique identifications pertaining to the plurality of text data; and
search the input expression based on a one or more predefined search rules and map the input expression to the plurality of hashes while maintaining the sequence;
a datastore module operatively connected with the ingestion engine and search engine, wherein the datastore module comprises:
an ingestion database operatively coupled to the ingestion engine, wherein the ingestion database is configured to store the plurality of ingested text data with the corresponding unique identification, and the generated hashes;
a search database operatively coupled to the search engine, wherein the search database is configured to store a plurality of search data and modified text data, modified by the user;
a rule engine operatively coupled to the search engine wherein the rule engine is configured to perform the search for the input expression based on the one or more pre-defined search rules; and
a result generation module operatively connected with the search engine and the rule engine, wherein the result generation module displays the search result as at least one of a document number and a text content in document.

2. The system as claimed in claim 1, wherein the text data of the plurality of text data comprises a document information, wherein the document information comprises a sub-sentence length, a starting point of the subsentence in the sentence, a sentence number in the document, a global index assigned to each sentence, and a document identification number to identify the input document.

3. The system as claimed in claim 1, wherein the plurality of text information comprises a sub-sentence length, a starting point of the subsentence in the sentence, a sentence number in the document, a global index assigned to each sentence, and a document identification number to identify the input document.

4. The system as claimed in claim 4, wherein the document identification number is generated when the document is ingested in the ingestion engine.

5. The system as claimed in claim 1, comprises a plug-in at a user side configured for communication between the processing subsystem and the user.

6. The system as claimed in claim 1, wherein the rule engine is flexible and customizable by the user.

7. The system as claimed in claim 1, wherein the search engine is configured to search the text in the third-party application hosted on the server.

8. The system as claimed in claim 1, wherein the ingestion database comprises a hash database and a document database.

9. A method for expression ingestion and expression search in multiple documents in real-time comprises:
receiving, by an ingestion engine of a processing sub-system, a plurality of text data wherein each of the plurality of text data comprises multiple sentences with a sequence of multiple words pertaining to an order of information;
assigning, by the ingestion engine of the processing sub-system, a unique identification to each of the plurality of the text data;
generating, by a tokenization module of the processing sub-system, a plurality of tokens for each sentence in each of the plurality of text data wherein the plurality of tokens is obtained by splitting each sentence into a plurality of sub-sentences wherein each sub-sentence comprises an incremental number of words pertaining to the sequence and incremental number of words with a start index of each sub sentence and creating subsentences ensuring that the order information is preserved;
generating, by the tokenization module of the processing sub-system, a plurality of hashes wherein each of the plurality of hashes comprises a hash, a sub-sentence length, a start index and a unique identification;
mapping, by the tokenization module of the processing sub-system, the plurality of hashes corresponding to each of the plurality of tokens;
generating, by the tokenization module of the processing sub-system, a plurality of hashes and match the plurality of hashes with pre-stored hashes, wherein the plurality of hashes is used to map a text data of arbitrary size value to fixed-size value;
storing, by an ingestion database of a datastore module, the plurality of text data with the corresponding unique number, wherein the ingestion database is a dynamic database;
storing, by a search database of the datastore module of the processing sub-system, a plurality of search data and modified text data, modified by the user;
receiving, by a search engine of the processing sub-system, a search query from a user to find an input expression from the plurality of text data;
splitting, by the tokenization module of the processing sub-system, the search query into sub-sentences with corresponding hashes;
searching, by the search engine of the processing sub-system, the hashes in the hash database and matching the hashes;
retrieving, by the search engine of the processing subsystem, a plurality of matched hashes in response to the searched hash, wherein the matched hashes indicate one or more corresponding unique identifications pertaining to the plurality of text data;
searching, by the search engine of the processing subsystem, the input expression based on a one or more predefined search rules and maps. the input expression to the plurality of hashes while maintaining the sequence;
performing, by a rule engine of the processing subsystem, the search for the input expression based on the one or more pre-defined search rules; and
displaying, by a result generation module, of the processing subsystem, the search result as at least one of a document number and a text content in the document.
